(19) United States
(12) Patent Application Publication
(10) Pub. No.: US 2017/0166416 A1
(43) Pub. Date: Jun. 15, 2017

(54) SMART WATCH FOR ELEVATOR USE

(71) Applicant: Otis Elevator Company, Farmington, CT (US)

(72) Inventor: Bradley Armand Scoville, Farmington, CT (US)

(21) Appl. No.: 15/116,446

(22) PCT Filed: Feb. 7, 2014
(86) PCT No.: PCT/US2014/015334

§ 371 Date: Aug. 3, 2016

(51) Int. Cl. B66B 1/34; H04M 1/725; G08C 17/02; B66B 1/46; G04B 47/00

(52) U.S. Cl. CPC B66B 1/3461; B66B 1/468; G04B 47/00; G08C 17/02; H04M 1/725; B66B 2201/4653; H04M 2250/02

(57) ABSTRACT

Embodiments are directed to providing, by a watch, an indication of a plurality of functions associated with an elevator system, receiving, by the watch, a selection of at least one of the functions, and communicating, by the watch, the selection of the at least one of the functions over a communication channel.

### BACKGROUND

Existing conveyance devices, such as elevators, are equipped with hardware to facilitate use and control. The hardware used represents an expense to a provider of the conveyance device or to an owner of a building where the conveyance device is located.

A user may request elevator service by depressing buttons on a hall call device located in proximity to an elevator hoist-way or entering a service request on a fixture, such as a kiosk located in a lobby of a building. Alternatively, applications associated with a smartphone may be used to request elevator service. The applications may be built on TCP/IP or other data protocols.

### BRIEF SUMMARY

An embodiment is directed to a method comprising: providing, by a watch, an indication of a plurality of functions associated with an elevator system, receiving, by the watch, a selection of at least one of the functions, and communicating, by the watch, the selection of the at least one of the functions over a communication channel.

An embodiment is directed to a watch comprising: at least one processor, and memory having instructions stored thereon that, when executed by the at least one processor, cause the watch to: provide an indication of a plurality of functions associated with an elevator system, receive a user selection of at least one of the functions, and communicate the selection of the at least one of the functions over a communication channel coupled to the watch.

An embodiment is directed to a controller of a conveyance system, comprising: at least one processor, and memory having instructions stored thereon that, when executed by the at least one processor, cause the controller to: receive a user selection provided at a watch coupled to the controller of at least one function of a plurality of functions associated with the conveyance system, and engage in an action corresponding to the selection of the at least one function.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a schematic block diagram illustrating an exemplary computing system;

FIG. 2 illustrates an exemplary block diagram of a system architecture;

FIG. 3 illustrates an exemplary block diagram of a system architecture using one or more communication techniques; and

FIG. 4 illustrates a flow chart of an exemplary method.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are described for enabling a watch to request conveyance device service and control one or more parameters associated with the operation of the conveyance device. In some embodiments, the watch may communicate with a smart device that may be in possession of a user. The smart device may, in turn, communicate with a server or (a controller of) the conveyance device. In some embodiments, the watch may communicate with the conveyance device.

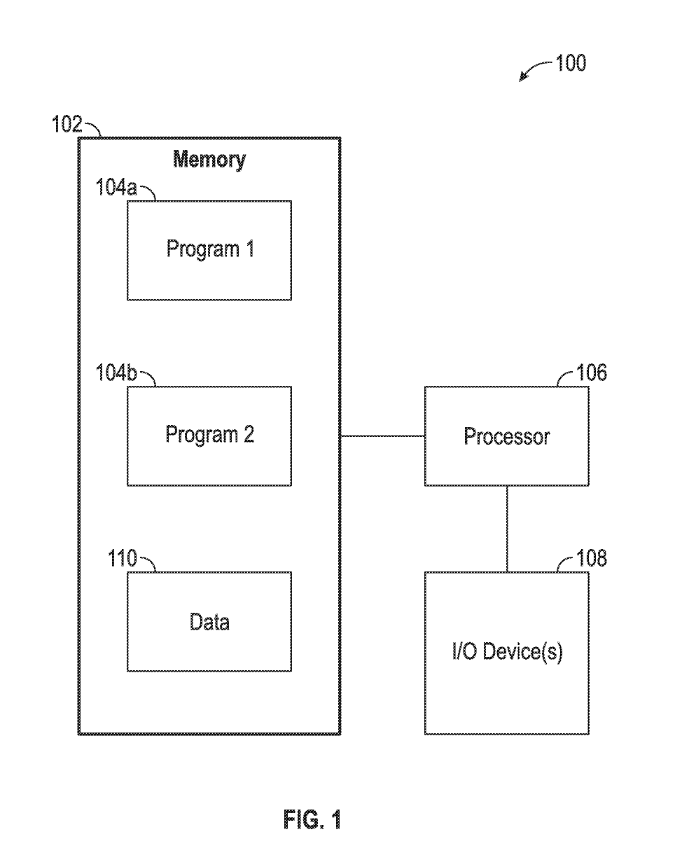

Referring to FIG. 1, an exemplary computing system 100 is shown. The system 100 is shown as including a memory 102. The memory 102 may store executable instructions. The executable instructions may be stored or organized in any manner and at any level of abstraction, such as in connection with one or more applications, processes, routines, procedures, methods, functions, etc. As an example, at least a portion of the instructions are shown in FIG. 1 as being associated with a first program 104a and a second program 104b.

The instructions stored in the memory 102 may be executed by one or more processors, such as a processor 106. The processor 106 may be coupled to one or more input/output (I/O) devices 108. In some embodiments, the I/O device(s) 108 may include one or more of a keyboard or keypad, a touchscreen or touch panel, a display screen, a microphone, a speaker, a mouse, a button, a remote control, a joystick, a printer, a telephone or mobile device (e.g., a smartphone), a sensor, etc. The I/O device(s) 108 may be configured to provide an interface to allow a user to interact with the system 100.

The memory 102 may store data 110. The data 110 may include data provided by one or more sensors, such as a two-dimensional (2D) or three-dimensional (3D) sensor. The data 110 may be processed by the processor 106 to control one or more parameters associated with a conveyance device.

The system 100 is illustrative. In some embodiments, one or more of the entities may be optional. In some embodiments, additional entities not shown may be included. For example, in some embodiments the system 100 may be associated with one or more networks. In some embodiments, the entities may be arranged or organized in a manner different from what is shown in FIG. 1.

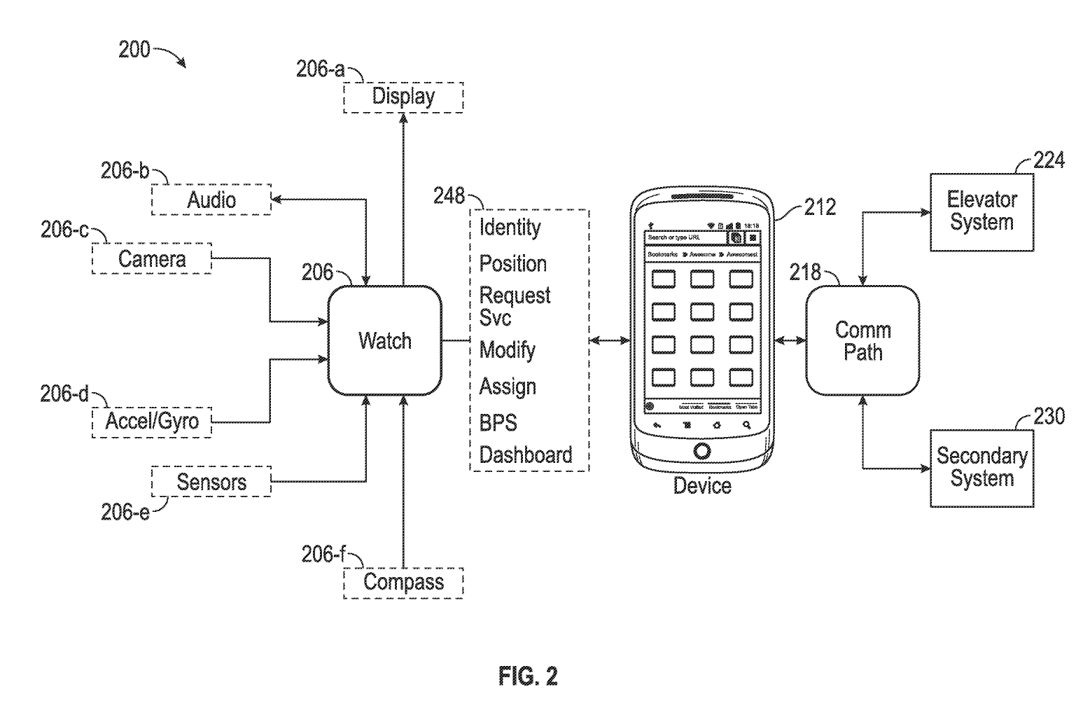

Turning now to FIG. 2, an exemplary system block diagram 200 in accordance with one or more embodiments is shown. The system 200 may include a watch 206, such as a wrist-watch or other jewelry that a person might ordinarily wear. The watch 206 may be a smart watch.

The watch 206 may be linked (e.g., wirelessly linked) to a device 212. The device 212 may include one or more of a tablet, a phone, a laptop, a personal computer (PC), etc. The device 212 may be a smart device.

The device 212 may communicate via a communication path 218 to one or more systems. For example, the device 212 may communicate with an elevator system 224 and a secondary system 230 (or one or more controllers associated with the systems 224 and 230). The secondary system 230 may include a building system or other non-elevator system.

The watch 206 may include one or more components or devices to facilitate the use or control of the elevator system 224 by a user associated with the watch 206 or the device 212. The components and devices are described below.

The watch 206 may include a display 206-a that may be used to provide a user with visual indicators or instructions.

The watch 206 may include audio equipment 206-b, such as a microphone or speakers, that may enable a user to generate commands and receive feedback in an auditory manner.

The watch 206 may include a camera 206-c, that may be used to take pictures or video of an environment, such as an area in proximity to the elevator system 224. In some embodiments, the camera 206-c may be used to take a picture of a bar code in a manner similar to a bar code scanner.

The watch 206 may include an accelerometer or gyroscope 206-d that may be used for purposes of, e.g., determining a position of the watch 206.

The watch 206 may include one or more sensors 206-e that may be used to determine and identify gestures that may be engaged in by a user associated with the watch 206.

The watch 206 may include a compass 206-f that may be used to provide a user of the watch 206 with a sense of direction as in connection with a conventional compass.

The watch 206 (and associated devices 206-a through 206-f) may be configured to provide any number of functions, denoted generally as 248 in FIG. 2, with respect to the system 200 or the elevator system 224. The functions 248 are described in further detail below.

A user may use the watch 206 to request elevator service (Request Svc). The service may be requested using one or more touch screens or buttons, audio capabilities, etc.

The watch 206 may be used to enter a destination (e.g., a destination floor) and obtain an assignment of an elevator or elevator car, potentially in a visual and/or auditory fashion.

Analytics may be provided, for example, in connection with facial, finger, or code recognition using the camera 206-c.

In some embodiments, the watch 206 may be used to direct the user to and from an elevator or elevator car, potentially based on the accelerometer/gyro 206-d and the compass 206-f in combination with a building positioning system (BPS). In this manner, the functionality provided by the watch 206 may be similar to the use of a global positioning system (GPS). The BPS may monitor different users in a building to optimize dispatching operations.

Elevator car speed, position, or an estimated time of arrival for an elevator car arriving at a floor or landing of origin or destination may be provided by the watch 206, e.g., using display 206-a or audio equipment 206-b.

Gesture-based interaction may be provided by the sensor(s) 206-e. For example, a user may wave her hand up and the elevator system 224 may recognize such a gesture as an up hall call. Similarly, the user may wave her hand down and the elevator system 224 may recognize this latter gesture as a down hall call. Gestures may be used to control the elevator doors.

In some embodiments, the watch 206 may be used to identify a user. Such a feature/function may be useful where access to a resource (e.g., a floor or landing) is restricted to authorized persons. In some embodiments, controls associated with the elevator system 224 may be based on an identity of a user.

In some embodiments, the watch 206 may be used to modify an elevator ride experience. For example, a user may control music playing in the elevator system 224, lighting within the elevator system 224, on-screen content available in the elevator system 224, etc. Access rights to control such features may be based on an identity of a user of the watch 206.

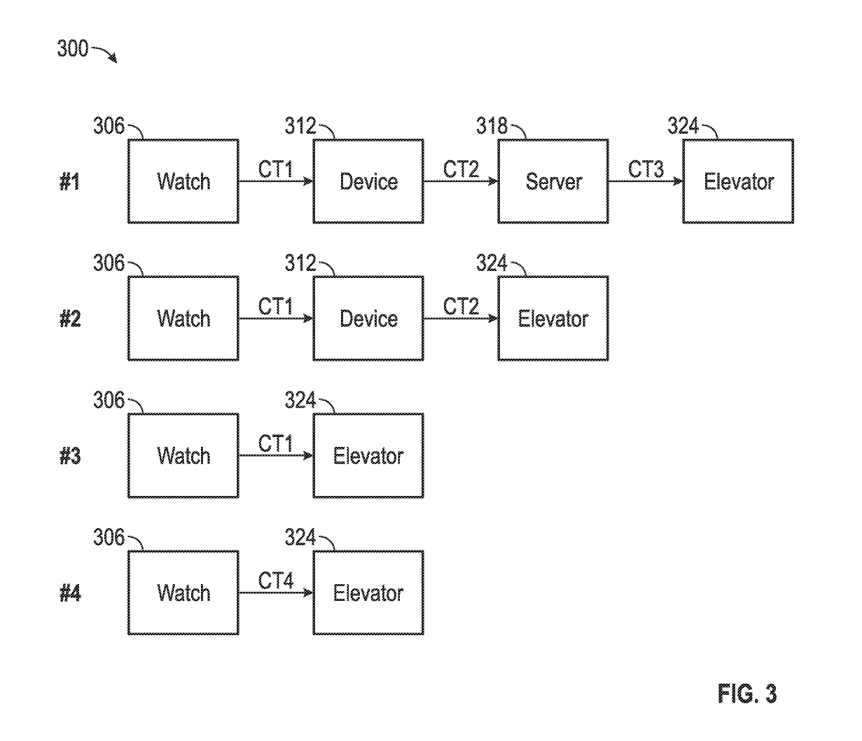

Turning now to FIG. 3, a system 300 in accordance with one or more embodiments is shown. The system 300 is shown as including a watch 306 (which may correspond to the watch 206), a device 312 (which may correspond to the device 212), a server 318 (which may include a cloud server), and an elevator 324 (which may be a part of the elevator system 224). The system 300 is shown in four exemplary configurations, labeled #1-4 in FIG. 3. These configurations #1-4 are described in further detail below.

In the first configuration #1, the watch 306 may communicate with the device using a first communication technique (CT1). The device 312 may communicate with the server 318 using a second communication technique (CT2). The server 318 may communicate with the elevator 324 using a third communication technique (CT3).

In the second configuration #2, the watch 306 may communicate with the device 312 using the first communication technique CT1. The device 312 may communicate with the elevator 324 using the second communication technique CT2.

In the third configuration #3, the watch 306 may communicate with the elevator 324 using the first communication technique CT1.

In the fourth configuration #4, the watch may communicate with the elevator 324 using a fourth communication technique (CT4).

In some embodiments, each of communication techniques CT1-CT4 may correspond to one or more of: Bluetooth communications, WIFI/Cell communications, Internet communications, and near field communications (NFC). Other standards, protocols, or techniques may be used. In the context of NFC communications, the watch 306 may talk directly to, e.g., the elevator 324 when in close range of or proximate to the elevator 324, which may be analogous to a user swiping an access card over a reader in RFID communications.

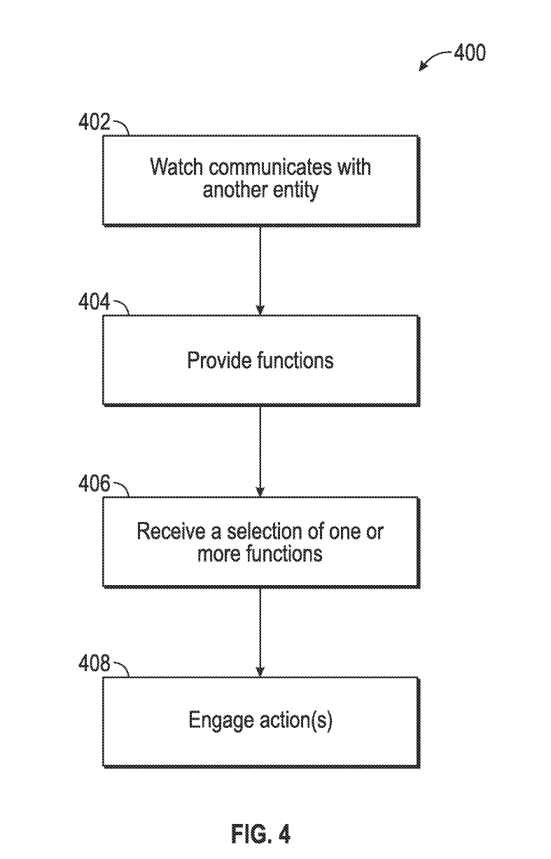

Turning now to FIG. 4, a method 400 is shown. The method 400 may be executed in connection with one or more systems, components, or devices, such as those described herein. The method 400 may be used to control the operation and functionality of an elevator from a user device, e.g., a watch.

In block 402, the watch may communicate with another entity or device, potentially over a communication channel. For example, the another entity or device may include a smart device (e.g., a phone), a server, an elevator or controller of the elevator, etc. The communication may be initiated by the watch or by the another device. The communication may be based on a user input. The communication may be based on the watch being within a threshold distance of the another device. The communication over the communication channel may occur using one or more communication techniques. The communication may be used to provide data or information of any kind or type.

In block 404, one or more functions associated with the elevator may be provided. For example, the watch may be configured to present a user with all of the functions associated with the elevator, or a subset of the functions that the user has access rights to.

In block 406, the watch may receive a selection of one or more of the functions of block 404. The selection may be communicated over the communication channel of block 402.

In block 408, one or more actions may be engaged based on the selection of block 406. For example, if the selection of block 406 includes a user request for elevator service based on an upward hand/watch gesture, an elevator car call may be placed for an elevator car to arrive at the floor that the user is currently located at to take the user in an upward direction (e.g., a high-numbered floor than the floor number the user is currently located at), and the user may be provided an indication via the watch as to an estimate as to when the elevator car is expected to arrive at the user's current floor. Similarly, the user may be requested to take a picture of herself using a camera integrated in the watch if access to one or more floors is restricted to authorized persons. Any number of actions may be taken in block 408, potentially based on the selection functionality of block 406.

The method 400 is illustrative. In some embodiments, one or more blocks or operations (or a portion thereof) may be optional. In some embodiments, the blocks may execute in an order or sequence different from what is shown in FIG. 4. In some embodiments, additional blocks not shown may be included.

Embodiments of the disclosure may provide user convenience, as the user might not need to take a phone out of her pocket or handbag to request service or engage functionality. Elevator calls may be placed in advance of when a user gets to a building or elevator. Aspects of the disclosure may be sued to provide on-trend integration into next generation ubiquitous devices. In some embodiments, a user may access elevator functionality in an anonymous fashion. If a user elects to register with an elevator system, additional services or features may be provided (e.g., VIP, elevator car preferences, etc.). Aspects of the disclosure may enhance features and capabilities for those with disabilities. For example, a watch may have voice capabilities, haptic feedback, etc.

A building owner or provider of elevator infrastructure may leverage one or more aspects of the disclosure to more efficiently provide elevator service and to control one or more elevators. For example, in accordance with one or more aspects of the disclosure, users may invest in hardware in lieu of a similar investment that might otherwise be made by the building owner or provider of the elevator infrastructure. The users might ordinarily invest in the hardware anyway, and thus, the hardware might not represent an additional or incremental cost.

While some of the examples described herein related to elevators, aspects of this disclosure may be applied in connection with other types of conveyance devices, such as a dumbwaiter, an escalator, a moving sidewalk, a wheelchair lift, etc.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method comprising:
providing, by a watch, an indication of a plurality of functions associated with an elevator system;
receiving, by the watch, a selection of at least one of the functions; and
communicating, by the watch, the selection of the at least one of the functions over a communication channel.

2. The method of claim 1, wherein the communication channel adheres to at least one of: Bluetooth communications, WIFI/Cell communications, Internet communications, and near field communications.

3. The method of claim 1, wherein the watch communicates the selection of the at least one of the functions to at least one of: a smart phone associated with a user of the watch, a cloud server, and a controller associated with the elevator system.

4. The method of claim 1, wherein the elevator system engages in one or more actions based on the selected at least one function.

5. A watch comprising:
at least one processor; and
memory having instructions stored thereon that, when executed by the at least one processor, cause the watch to:
provide an indication of a plurality of functions associated with an elevator system;
receive a user selection of at least one of the functions; and
communicate the selection of the at least one of the functions over a communication channel coupled to the watch.

6. The watch of claim 5, further comprising:
a compass; and
at least one of an accelerometer and a gyroscope,
wherein the instructions, when executed, cause the watch to:
provide directions to the elevator system using the compass and the at least one of an accelerometer and a gyroscope.

7. The watch of claim 5, further comprising:
a sensor configured to detect motion of the watch,
wherein the instructions, when executed, cause the watch to:
interpret the detected motion as a gesture that maps to the selected at least one of the functions.

8. The watch of claim 5, further comprising:
a camera,
wherein the instructions, when executed, cause the watch to:
provide analytics using the camera; and
communicate a result of the analytics over the communication channel.

9. The watch of claim 8, wherein the result of the analytics comprises an identification of a user of the watch.

10. The watch of claim 5, wherein the communication channel adheres to at least one of: Bluetooth communications, WIFI/Cell communications, Internet communications, and near field communications.

11. The watch of claim 5, wherein the watch is configured to communicate the selection of the at least one of the functions to at least one of: a smart phone associated with a user of the watch, a cloud server, and a controller associated with the elevator system.

12. The watch of claim 5, wherein the instructions, when executed, cause the watch to:
receive a request for elevator service; and
communicate the request for elevator service over the communication channel.

13. A controller of a conveyance system, comprising:
at least one processor; and
memory having instructions stored thereon that, when executed by the at least one processor, cause the controller to:
receive a user selection provided at a watch coupled to the controller of at least one function of a plurality of functions associated with the conveyance system; and
engage in an action corresponding to the selection of the at least one function.

14. The controller of claim 13, wherein the controller is configured to receive the user selection from at least one of:
the watch,
a smart phone associated with a user of the watch, and
a cloud server.

15. The controller of claim 13, wherein the controller is configured to schedule service for a user of the watch based on a request for service provided at the watch.

16. The controller of claim 13, wherein the conveyance system comprises an elevator system, and wherein the controller is configured to provide the watch an indication of an assignment of an elevator, the indication configured for presentation by the watch.
